(19) United States
(12) Patent Application Publication
(10) Pub. No.: US 2014/0206495 A1
(43) Pub. Date: Jul. 24, 2014

(54) MECHANICAL ENERGY STORAGE SYSTEM

(71) Applicants: Joerg Heyse, Besighelm (DE); Thomas Schniedertoens, Stuttgart (DE); Andy Tiefenbach, Vaihingen-Horrheim (DE)

(72) Inventors: Joerg Heyse, Besighelm (DE); Thomas Schniedertoens, Stuttgart (DE); Andy Tiefenbach, Vaihingen-Horrheim (DE)

(21) Appl. No.: 13/994,978

(22) PCT Filed: Oct. 20, 2011
(86) PCT No.: PCT/EP11/68347

§ 371 Date: Mar. 31, 2014

(30) Foreign Application Priority Data
Dec. 17, 2010 (DE) 10 2010 063 335.6

(51) Int. Cl. H02K 7/02; F16H 1/28

(52) U.S. Cl. CPC H02K 7/025; F16H 1/28
USPC 475/331

(57) ABSTRACT

A mechanical energy storage system and an electric or hybrid vehicle with an energy storage system of this type are provided. The energy storage system has a planetary gear. The sun wheel of same is connected to an electric motor of the vehicle. An outer wheel of the planetary gear is connected to a wheel drive of the vehicle. The planet wheels are connected rigidly to one another via a planet wheel linkage. To increase the flywheel mass, the planet wheels have “flywheel mass regions” which have a larger diameter than a gearwheel region situated between the sun wheel and the outer wheel. Due to these flywheel mass regions, a considerable amount of rotational energy may be stored in the rotating planet wheels with the planetary gear. Such a storage of kinetic energy is intended to improve a degree of recuperation or the starting characteristics of an electric vehicle.

### FIELD OF THE INVENTION

The present invention relates to a mechanical energy storage system, which may be used in a vehicle, in particular in an electric or hybrid vehicle. Furthermore, the present invention relates to a vehicle having such a mechanical energy storage system.

### BACKGROUND INFORMATION

Electric and hybrid vehicles are usually driven in part by an electric motor, which may also be operated in a generator mode. To reduce total energy consumption, it is desirable to recuperate kinetic energy when braking the vehicle, i.e., to recover the energy and store it for later use.

It is believed to be customary to operate the electric machine in generator mode during a braking operation to convert kinetic energy into electrical energy and then be able to store it in the vehicle battery. Independently of such recuperation and storage of electrical energy, vehicles using a flywheel mechanism in which kinetic energy released during braking is stored mechanically have also been proposed.

However, it has been recognized that, at least in many driving and braking situations, conventional recuperation mechanisms cannot result in a satisfactory energy recuperation and energy storage.

### SUMMARY OF THE INVENTION

There may therefore be a demand for a mechanism for energy recuperation and a vehicle equipped with such a mechanism, so that kinetic energy of the vehicle or energy provided by an electric motor operated in the vehicle may advantageously be stored and dispensed again as needed.

The subject matter of the systems described herein is intended to meet such a need. Advantageous embodiments are defined in the further descriptions herein.

According to a first aspect of the present invention, a mechanical energy storage system for a vehicle, in particular for an electric or hybrid vehicle, is proposed. The energy storage system has a planetary gear. A sun wheel on the planetary gear is connected to the motor of the vehicle in a rotatably fixed manner. In electric or hybrid vehicles, this motor is an electric motor, which may also be operated as a generator, so that force may be transferred from the motor to the sun wheel as well as in the reverse direction. An outer wheel of the planetary gear is connected to a wheel drive on the vehicle to drive the vehicle wheel to rotate. Planet wheels of the planetary gear are fixedly connected via a planet wheel linkage. According to the present invention, the planet wheels have so-called flywheel mass regions, to increase their flywheel mass, which have a larger diameter than a gearwheel region of the planetary gears situated between the sun wheel and the outer wheel.

According to a second aspect of the present invention, a vehicle is proposed, in particular an electric or hybrid vehicle equipped with a mechanical energy storage system according to the present invention.

Findings and ideas on which aspects of the present invention or its specific embodiments are based are described briefly, and features and advantages of specific embodiments according to the present invention are described.

It has been recognized that in certain energy recuperations in vehicles by conversion into electrical energy and subsequent storage in the vehicle battery, a maximum amount of recuperable energy to be recovered or the recuperation power may be limited by the intake capacity of the vehicle battery. The braking energy is often stored only inadequately in the form of recuperated electricity in the battery, in particular during more intense vehicle deceleration because complete conversion of kinetic energy into electrical energy and subsequent storage of same could result in overloading the electrical components of the vehicle, in particular the power electronics and the battery. During hard braking actions, a portion of the braking energy is therefore often destroyed by frictional heat due to additional conventional mechanical braking in the brake disk.

With the mechanical energy storage system proposed here, in addition to the possibility of recuperation and storage of electrical energy, an option may be created of also storing energy in a vehicle mechanically, in particular in the form of rotational energy. The vehicle is therefore equipped with an additional flywheel drive in the form of a specially configured planetary gear. The flywheels, with the aid of which mechanical rotational energy is to be stored, are provided in the form of planet wheels of the planetary gear. To maximize the rotational energy storable in these flywheels, the planet wheels are configured in such a way that they have the highest possible moment of inertia and rotate as rapidly as possible during operation of the planetary gear.

To maximize the flywheel mass and the moment of inertia, the planet wheels are provided with additional flywheel mass regions. These flywheel mass regions are connected in a rotatably fixed manner to a gearwheel region of the particular planet wheel, which is situated between the sun wheel and the outer wheel, as in conventional planetary gears, and may be induced to rotate by the sun wheel or the outer wheel. One flywheel mass region is configured to be rotationally symmetrical around an axis of rotation of the particular planetary gear and may have a circular disk shape, for example. A diameter of a flywheel mass region here is larger than the diameter of a planet wheel in the gearwheel region. It is possible in this way to achieve the result that a large portion of the mass contained in the flywheel mass regions is a relatively great distance away from the axis of rotation, whereby the moment of inertia of the entire planet wheel is substantially increased, and thus more kinetic energy may be stored in the planet wheel in the form of rotational energy at the same rotational speed.

To achieve the highest possible rotational velocity of the planet wheel during operation of the planetary gear, the gear ratio between the sun wheel and the planet wheels may be at least 20:1, which may be at least 30:1, and which may be at least 50:1. In other words, the planet wheel may have a diameter in the area of the gearwheel region which is so small in relation to the diameter of the sun wheel that the desired gear ratio is obtained on the basis of the number of teeth of the planet wheel situated in the area of the gearwheel region in relation to the number of teeth on the sun wheel. Due to such a high gear ratio, a high rotational speed and thus also a high rotational velocity of the planet wheels and the associated flywheel mass regions may also be achieved even at a low rotational speed of the sun wheel.

To achieve a high moment of inertia of the planet wheels and thus a high energy storage capacity, the diameter of the flywheel mass regions of the planet wheels may be at least twice as large, which may be at least three times as large and which may be at least five times as large as the diameter of the gearwheel regions. The diameter of the gearwheel regions is largely determined by the distance between the sun wheel and the outer wheel within the planetary gear and is typically in the range of 0.5 cm to 2 cm in electric vehicles. In order for the flywheel mass regions to have a larger diameter between 1 cm and 10 cm, for example, the flywheel mass regions may be situated outside of the actual planetary gear, i.e., in a plane which is offset in parallel to the plane in which the sun wheel, the outer wheel and the gearwheel regions of the planet wheels are situated.

To implement an advantageous distribution of force on the planet wheels on the one hand and to maximize the flywheel mass associated with the gearwheel regions of the planet wheels on the other hand, the planet wheels may be provided with flywheel mass regions on the two axial ends. The flywheel mass regions may be configured to be identical.

Furthermore, the planet wheels may be configured in one piece, i.e., the gearwheel region and the flywheel mass region(s) may be configured to be integral. Due to such a one-piece design, a sufficiently high mechanical stability may be achieved, to withstand the forces which occur during rapid rotation of the planet wheels and in particular their flywheel masses.

The planet wheels may be made partially or entirely of metal. Due to the generally high unit weight of most metals, it is possible in this way to achieve a large flywheel mass with high mechanical resilience at the same time. Metals that may be used include 16MnCr5, 20MnCr5, 18CrMo4, for example.

Alternatively or additionally, the planet wheels may be made of a synthetic fiber material. In particular when using high-strength synthetic fibers, for example, carbon fibers or Kevlar fibers, such synthetic fiber materials may allow an extremely high mechanical resilience of the planet wheels made of such materials. Due to this high resilience, it may be possible to have the planet wheels rotate at extremely high rotational speeds. Since the rotational energy Eᵣₒₜ stored in such a rotation depends quadratically on the rotational speed or angular speed ω, but only linearly on the moment of inertia J (Eᵣₒₜ=1/2 J ω²), a large amount of rotational energy may also be stored with planet wheels made of a comparatively lightweight synthetic fiber material due to the high mechanical resilience and the high permissible rotational velocity associated with this. Furthermore, the design size of the planetary gear may be kept low due to usable small but high-resilience planet wheels.

The planet wheels of the mechanical energy storage system proposed here may be configured with regard to their geometry and with regard to the permissible mechanical resilience during rotation in such a way that during normal operation, i.e., at typically occurring rotational speeds within the planetary gear, a rotational energy of at least 1000 J, which may be at least 2000 J, may be stored. The option of mechanically storing such a large quantity of energy has proven advantageous in particular in cases when electric vehicles are to accelerate from a stop on an incline, for example, or when starting on a curb, for example.

A vehicle, in particular an electric or hybrid vehicle, equipped with a mechanical energy storage system according to the present invention may be configured to store energy in the form of rotational energy in the planet wheels of the mechanical energy storage system during a braking operation and/or to supply rotational energy stored in the planet wheels of the mechanical energy storage system during an acceleration process to the vehicle for conversion into kinetic energy, i.e., for acceleration of the vehicle. Support of the electric motor, for example, during starting on an incline or during more intense acceleration, may thus also be enabled in addition to the energy recuperation during braking operations already described above. Such a short-term increase in power is also known as “power boost.” In conventional electric vehicles, such a power boost was possible only to a limited extent in some cases since the electrical power to be switched for an additional power application to the electric motor could excessively heat up the electronic power equipment or could result in an overload of the electronic power equipment, in particular in the inverter. This has in some cases even resulted in the limited power not being sufficient for starting on an incline. Due to the additional energy storage in the mechanical energy storage system proposed herein, the starting characteristic and a power boost may be improved.

In one specific embodiment, the vehicle has two mechanical energy storage systems according to the present invention, a first energy storage system being configured to have the planet wheels rotate in the opposite direction from a second energy storage system for storing rotational energy. This makes it possible to prevent a change in direction of the vehicle from being made difficult due to Coriolis forces. The opposite direction of rotation of the planet wheels may be achieved, for example, by a transmission on the electric motor and a transmission on the wheel drive for reversing the direction of rotation of the electric motor and the wheel rotation.

Alternatively, the mechanical energy storage system may be situated in the vehicle in such a way that the planet wheels rotate about a vertical axis. The vertical axis is understood to be an axis orthogonal to a plane along which the vehicle moves during driving. In the event of such an installation of the energy storage system in the vehicle in which the planet wheels are positioned horizontally and are able to rotate about a vertical axis, Coriolis forces do not act against a change in direction of the vehicle but instead may stabilize it in the position of its vertical axis to thereby counteract a vehicle rollover, for example. An implementation of the installed position of the planetary gear may be achieved via a bevel gear on the side of the wheel drive and by horizontal installation of the electric machine.

With the aid of the mechanical energy storage system proposed herein and a vehicle equipped with such an energy storage system, a plurality of advantages may be achieved, for example:
It is possible to improve the degree of recuperation, i.e., a utilization of braking energy may also be increased during more intense braking operations. Indirectly the range of the electric vehicle may be increased in this way. The influence of the vehicle mass to be accelerated on the range is reduced through the improved recuperation; in other words an increased vehicle weight plays a lesser role. A maximum degree of recuperation may be achieved here with a maximum moment of inertia of the flywheel mass regions provided on the planet wheels.
Due to the improved degree of recuperation, the lifetime of brake disks and brake linings may be prolonged due to the lower brake stress.
With the aid of the rotational energy stored in the mechanical energy storage system, starting on inclines in particular may be improved by connecting the flywheel masses to the electric drive.
A substantial power boost may be achieved while driving by connecting the flywheel masses to the electric drive.
The design of the mechanical energy storage system having the planetary gear permits an inexpensive and robust implementation of the mechanical energy storage.
The operating point of an electric motor in which the rotational speed is selected, taking into account the torque, may be optimized by utilizing the additional mechanical energy storage system via recuperation.
When starting under load the rotational energy stored in the mechanical energy storage system may be utilized to avoid the jerking typical of electric vehicles.
When using mechanical energy storage systems for all four wheels of a vehicle, a four-wheel drive functionality may be implemented.

It should be pointed out that ideas about the present invention are described here in conjunction with the mechanical energy storage system and also with a vehicle equipped with such an energy storage system and also in conjunction with certain function modes of such a vehicle and energy storage system. It will be clear to those skilled in the art that the individual features described here may be combined with one another in various ways to also yield other embodiments of the present invention.

Specific embodiments of the present invention, which are not to be interpreted restrictively, are described below with reference to the accompanying figures. The figures are only schematic and are not drawn true to scale.

### BRIEF DESCRIPTION OF THE DRAWINGS

FIG. 1 shows a side view of a mechanical energy storage system according to the present invention.

FIG. 2 shows a sectional view of a mechanical energy storage system according to the present invention.

FIG. 3 shows a planet wheel for a mechanical energy storage system according to the present invention.

FIG. 4 shows a highly schematic illustration of a vehicle having an energy storage system according to the present invention.

FIGS. 5 through 13 illustrate types of functions such as those which may be implemented using an energy storage system according to the present invention.

### DETAILED DESCRIPTION

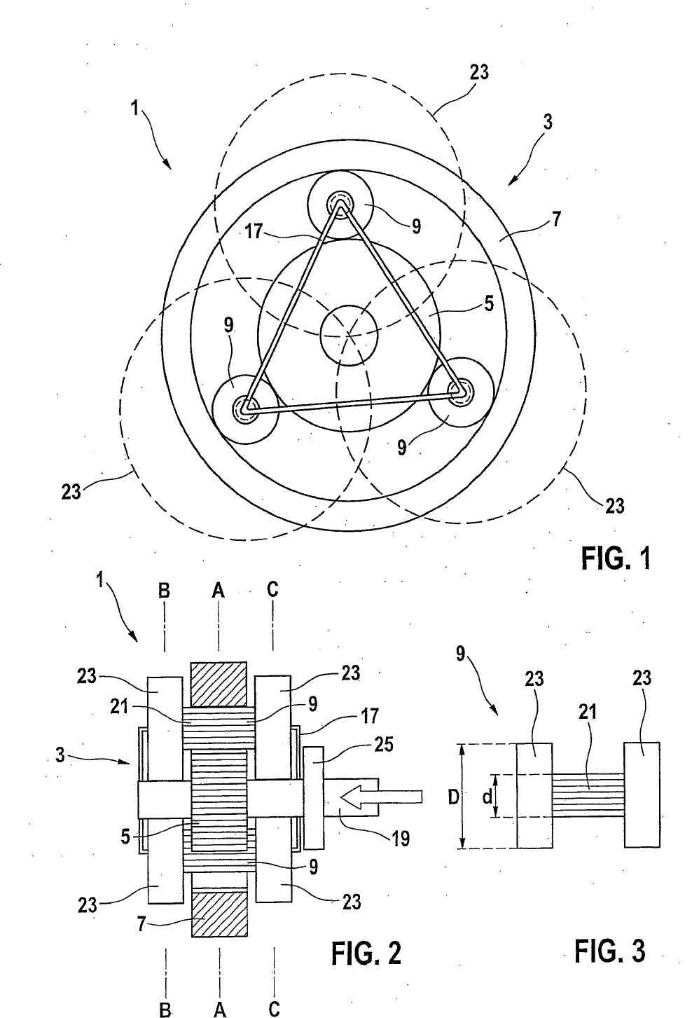

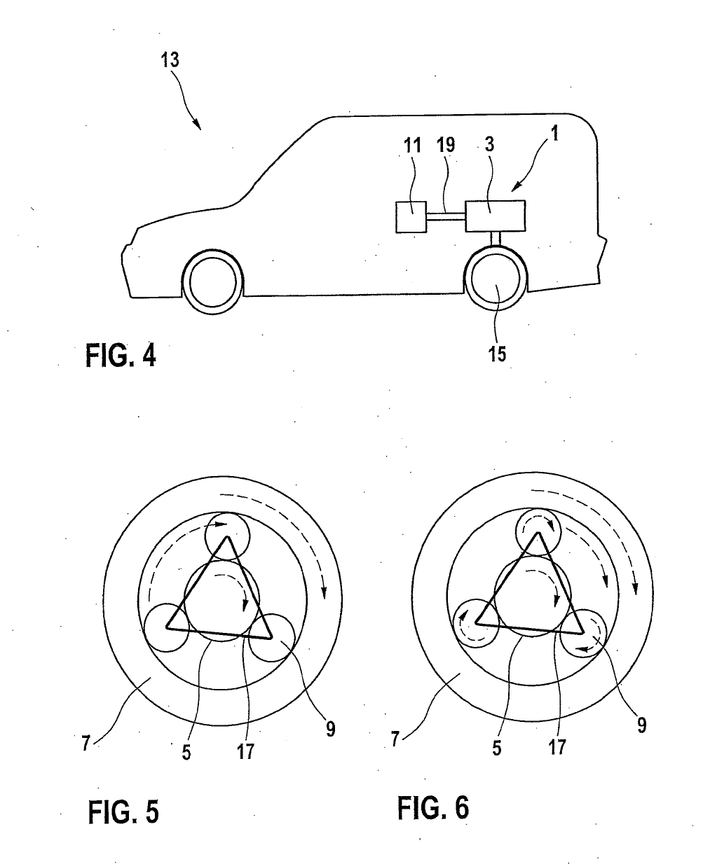

FIG. 1 and FIG. 2 show a mechanical energy storage system according to the present invention in a side view and in a cross-sectional view. An energy storage system according to the present invention may be used in an electric or hybrid vehicle, as illustrated schematically in FIG. 4.

Energy storage system 1 has a planetary gear 3. Planetary gear 3 has a central sun wheel 5, an outer wheel 7 and three planet wheels 9 situated between sun wheel 5 and outer wheel 7. Teeth (not shown in FIG. 1) are provided on an outer circumference of sun wheel 5 and on an inner circumference of outer wheel 7 so that the teeth of planet wheels 9 may engage with the former teeth so that a rotation of sun wheel 5 and outer wheel 7 causes a corresponding rotation and/or movement of planet wheels 9. Sun wheel 5 is connected via a shaft 19 to an electric motor 11 of vehicle 13 (see FIG. 4) in a rotatably fixed manner. Outer wheel 7 is connected to a wheel drive for driving wheels 15 in a rotatably fixed manner. Three planet wheels 9 are rigidly interconnected by a planet wheel linkage 17.

FIG. 3 shows a planet wheel 9 of planetary gear 3. Planet wheel 9 has a gearwheel region 21 situated between sun wheel 5 and outer wheel 7 in planetary gear 3, as shown in FIG. 2, and engages with them through teeth situated thereon. Flywheel mass regions 23 are formed on each axial end of planet wheel 9. These flywheel mass regions are implemented as circular disks having a larger diameter D than diameter d of gearwheel region 21.

As shown in FIG. 2, flywheel mass regions 23 are outside, i.e., with a lateral offset from a plane A-A of planetary gear 3 in which the gearwheel faces intermesh. In FIG. 2 flywheel mass regions 23 of planet wheels 9 are configured in such a way that they are situated in equal planes B-B, C-C. However, the maximum possible diameter of flywheel mass regions 23 is limited since flywheel mass regions 23 of adjacent planet wheels 9 must not come in contact.

To achieve larger diameters for flywheel mass regions 23, the disks situated at the ends of adjacent planet wheels 9 may be offset in relation to one another, so that they do not come in contact due to an axial gap between them. Planet wheels having very large flywheel mass regions 23, which may overlap in a side view, as shown schematically using broken lines in FIG. 1, may be implemented in this way.

Various types of functions in which the mechanical energy storage system described here and an electric vehicle equipped therewith may be operated will be described below with reference to FIGS. 5 through 13.

FIG. 5 illustrates driving without power booster operation and without recuperation. The axes of rotation of sun wheel 5 and planet wheel assembly 9, 17 are shown here rigidly coupled to one another. Planet wheels 9 do not rotate about their own axis. Electric motor 11 drives outer wheel 7 and wheel 15, which is connected thereto.

To enable coupling of the axes of sun wheel 5 and planet wheel assembly 9, 17 rigidly to one another, driving flange 25 (see FIG. 2), which is a local thickening of sun wheel axle 19, is pressed by axial displacement of sun wheel axle 19 onto planet wheel linkage 17.

If, as shown in FIG. 6, the axes of rotation of sun wheel 5 and planet wheel assembly 9, 17 are decoupled from one another and electric machine 11 is switched to generator operation, electric machine 11 recuperates in the form of generating electrical power and planet wheels 9 recuperate in the form of intake of rotational energy. This increases the total recuperable power and the braking power. Vehicle 13 is braked in a first braking phase.

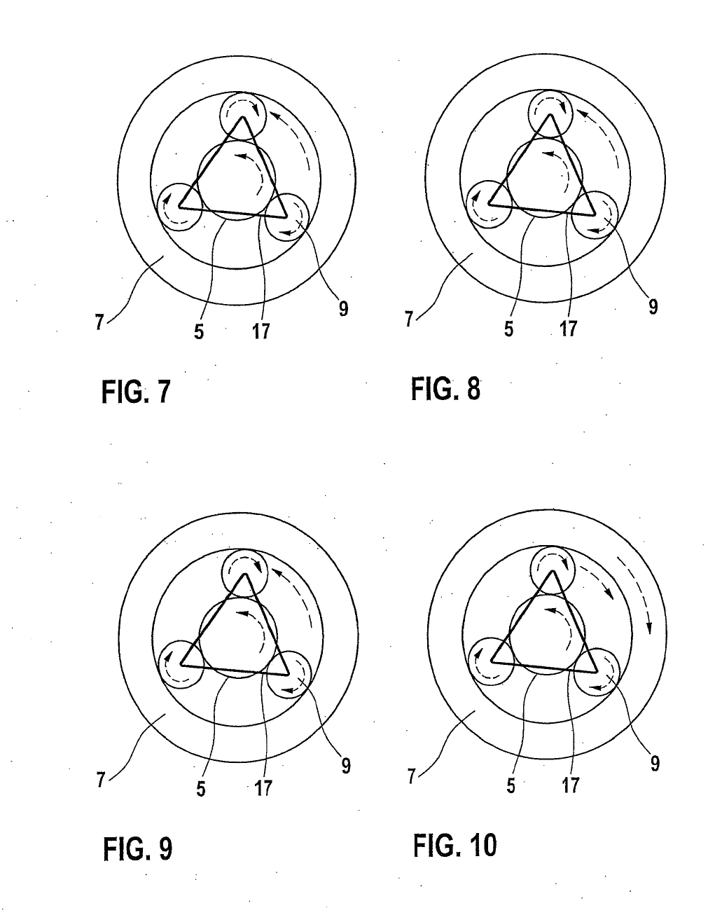

In the second braking phase, shown in FIG. 7, until the vehicle comes to a stop, electric machine 11 is operated opposite the direction of rotation during the first braking phase. The flywheel masses provided on planet wheels 9 continue to charge themselves with rotational energy. Wheel 15 is further decelerated due to the acceleration of the inertial masses. This means that the vehicle is decelerated by electric machine 11 and the braking energy is stored in flywheel masses 23. Shortly before the vehicle comes to a stop or in the event of an emergency braking action, the vehicle may be brought to a stop by the conventional wheel brake.

The wheel brake remains activated after the vehicle has stopped, as shown in FIG. 8. Electric machine 11 recuperates the kinetic energy of planet wheels 9. In other words, the total braking power from the two braking phases may be recuperated by electric machine 11 over a longer period of time than the braking operation. Consequently, the amperage to be received by the battery is reduced to the extent that the battery is not overloaded. This is also true after a braking action which has not yet resulted in a vehicle stoppage.

As an alternative, electric machine 11 may be idling after a complete braking action and a subsequent vehicle stoppage, as illustrated in FIG. 9, so that the rotational energy of planet wheels 9 remains stored for a subsequent power boost operation. If, after no prior recuperation, planet wheels 9 do not have any kinetic rotational energy (for example, at the vehicle start), these wheels may be caused to rotate by electric machine 11 before starting with the wheels locked by the mechanical wheel brake.

As illustrated in FIG. 10, the vehicle may be accelerated by the rotational energy of planet wheels 9 during starting. Electric motor 11, which was previously operated in idling mode, is decelerated recuperatively; wheel 15 begins to rotate. In addition, the vehicle may be accelerated by electric motor 11 in that the latter is driven opposite the direction of rotation as illustrated in FIG. 9.

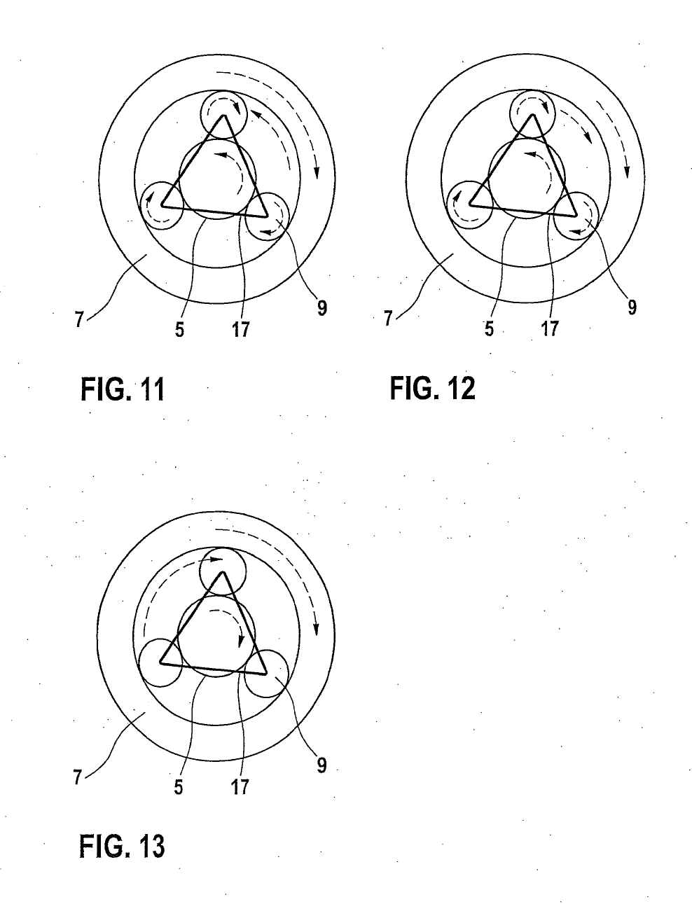

As shown in FIG. 11, the vehicle may then coast in that electric machine 11, planet wheels 9 and wheel 15 are in idling mode.

After such coasting, the vehicle may be accelerated as shown in FIG. 12 via the rotational energy stored in flywheel masses 23 and additionally accelerated via electric machine 11 for a power boost operation, for example. If only the kinetic energy of planet wheels 9 is to be used for acceleration, electric machine 11 is braked recuperatively while idling. When the acceleration is supported by electric machine 11 (power boost operation), the latter is driven in the opposite direction of rotation from that in the preceding idling.

For cruising after a power boost as shown in FIG. 13, the axes of rotation of sun wheel 5 and planet wheel assembly 9, 17 are rigidly coupled to one another for cruising as soon as they are rotating synchronously. Planet wheels 9 do not rotate further about their own axis. The coupling of the two axles should always take place after they reach the same rotational speed; otherwise, further acceleration of the vehicle by electric machine 11 could take place only with slippage via planet wheels 9, which are then caused to rotate. The vehicle could not be adequately accelerated without coupling the axles or it would decelerate under load on an incline despite acceleration by electric machine 11.

To be able to store as much rotational energy as possible in planet wheels 9 equipped with flywheel mass regions 23, their moment of inertia should be as high as possible on the one hand and there should be the possibility of inducing the fastest possible rotation of planet wheels 9 on the other hand. For rapid rotation, the planet wheels in gearwheel region 21 should have the smallest possible diameter to thereby enable a high transmission ratio between planet wheels 9 and sun wheel 5. A gear ratio to be sought may amount to 30:1, for example, i.e., the rotational speed of planet wheels 9 is thirty times higher than the rotational speed of sun wheel 5 or the rotational speed of vehicle wheels 15.

On the other hand, the flywheel masses provided on the axial ends of planet wheels 9 should have the highest possible inertia, i.e., the highest possible moment of inertia. For example, it may be sought to store enough rotational energy in the planetary gear to be able to transfer energy of 2000 J to a vehicle of 1000 kg weight which is sufficient for starting on a curb 20 cm high. Assuming the mechanical energy storage system “is charged up” at a driving speed of 50 km/h, the planet wheels then rotating at a rotational speed of approximately 12,000 revolutions per minute at a gear ratio of 30:1 and further assuming that the planet wheels including the flywheel mass regions are made of steel having a flywheel mass region thickness of 20 mm, it is possible to calculate that a diameter of the flywheel mass region should be greater than 72 mm.

1-12. (canceled)

13. A mechanical energy storage system for a vehicle, comprising:
a planetary gear;
a sun wheel of the planetary gear being connected to a motor of the vehicle;
an outer wheel of the planetary gear being connected to a wheel drive of the vehicle; and
planet wheels being interconnected via a planet wheel linkage;
wherein the planet wheels have flywheel mass regions to increase their flywheel mass, these flywheel mass regions having a larger diameter than a gearwheel region of the planet wheels situated between the sun wheel and the outer wheel.

14. The mechanical energy storage system of claim 13, wherein a gear ratio between the sun wheel and the planet wheels amounts to at least 20:1.

15. The mechanical energy storage system of claim 13, wherein a diameter of the flywheel mass regions of planet wheels is at least twice as large as a diameter of the gearwheel regions.

16. The mechanical energy storage system of claim 13, wherein the planet wheels are provided with flywheel mass regions on both axial ends.

17. The mechanical energy storage system of claim 13, wherein the planet wheels are configured in one piece.

18. The mechanical energy storage system of claim 13, wherein the planet wheels are made of metal.

19. The mechanical energy storage system of claim 13, wherein the planet wheels are made of a synthetic fiber material.

20. The mechanical energy storage system of claim 13, wherein the planet wheels are configured to store a rotational energy of at least 1000 J.

21. A vehicle, comprising:
a mechanical energy storage system for a vehicle, including:
a planetary gear;
a sun wheel of the planetary gear being connected to a motor of the vehicle;
an outer wheel of the planetary gear being connected to a wheel drive of the vehicle; and
planet wheels being interconnected via a planet wheel linkage;
wherein the planet wheels have flywheel mass regions to increase their flywheel mass, these flywheel mass regions having a larger diameter than a gearwheel region of the planet wheels situated between the sun wheel and the outer wheel.

22. The vehicle of claim 21, wherein the vehicle is configured to store energy in the form of rotational energy in the planet wheels (9) of the mechanical energy storage system (1) during a braking operation and/or to supply the rotational energy stored in the planet wheels of the mechanical energy storage system to the vehicle for conversion into kinetic energy during an acceleration operation.

23. The vehicle of claim 21, additionally having a second mechanical energy storage system as recited in one of claims 1 through 8, which is configured for storing rotational energy to rotate the planet wheels in the opposite direction from that of the first mechanical energy storage system.

24. The vehicle of claim 21, wherein the mechanical energy storage system is situated in the vehicle in such a way that the planet wheels rotate about a vertical axis.
